(19) United States
(12) Patent Application Publication
(10) Pub. No.: US 2025/0209853 A1
(43) Pub. Date: Jun. 26, 2025

(54) Deep Learning-Based Prediction of Personality and Moral Values through Facial Emotion Recognition

(71) Applicant: Peter A. Gloor, Charlestown, MA (US)

(72) Inventor: Peter A. Gloor, Charlestown, MA (US)

(21) Appl. No.: 19/077,809

(22) Filed: Mar. 12, 2025

Related U.S. Application Data
(63) Continuation-in-part of application No. 17/890,617, filed on Aug. 18, 2022.

(51) Int. Cl. G06V 40/16; G06V 10/82

(52) U.S. Cl. CPC G06V 40/176; G06V 10/82

(57) ABSTRACT

Disclosed in the present inventions is a human personality and morals prediction system. In particular, the inventions disclose a system of predicting personality and morals through facial emotion recognition. A computer-implemented system for predicting personality and morals through facial emotion recognition, comprising a machine learning system that predicts personality characteristics of individuals on the basis of their face. Also disclosed are methods of tracking the emotional response of the individual's face through facial emotion recognition (FER) while watching a series of 15 short videos of different genres; and calibration of emotional responses for analysis through their facial expression.

### CROSS-REFERENCE TO RELATED APPLICATIONS

This application is a continuation-in-part of U.S. patent application Ser. No. 17/890,617, filed by Peter A. Gloor on Aug. 18, 2022, said application is incorporated by reference herein in its entirety

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present inventions relate to artificial intelligence (AI) and deep learning applications in psychology, specifically to systems and methods for predicting personality traits, moral values, and risk-taking behavior using facial emotion recognition (FER) techniques.

### BACKGROUND

Humans judge other humans based on their face images, predicting personality traits (such as generosity, reliability), capabilities (intelligence, precision) even guessing professions (a teacher, a care-giver, a lawyer) from a face image alone. Psychological research has found a high degree of correlation in such judgments (different people interpreting the same face image in a similar manner). Moreover, psychological research has also found a certain degree of correlation between face appearances and ground truth or real-world performance (successful CEO, winning martial arts fighter, etc).

Psychologists, counsellors, coaches, therapists gather information on one's personal traits and those of others to analyse and advise on interactions in the social and business domains. However, it is clear that different people have different judgment capabilities, some judgments may be pure prejudice, and in any case it is impractical to rely on human judgment to process high-volumes of data in an efficient and repeatable manner.

In the prior art, face image analysis techniques have been provided to detect the emotional state of a person—e.g. anger/happiness/sadness by tracking or recognizing an expression defined by certain deformation of the face image as measured for example from the relative distances between facial landmarks, e.g., as disclosed by US Patent Publication No. 2011/0141258 “emotion recognition method and system thereof”. In contrast, the present inventions measure traits or fixed personality characteristics which do not change over time. Actually, a neutral expression is preferred, as non-neutral expression, in particular an extreme emotional state, may distort the usual appearance of the person being analysed.

Existing systems for personality trait prediction from text do the prediction separately for different sources of data, like social media, call detail records, and email. There are systems available that disclose multiple ways of performing personality prediction from text. The detection of different personality from text has been used widely across multiple fields, for example, in one of the main areas, the hiring process wherein personality prediction from text is currently used for determining: whether a personality is suitable for a testing job, as a research manager, etc. . . . ?, or whether he/she a good team player?.

Personality prediction also helps to understand the state of personality, namely confused, organized, abstract, or definitive. There are different techniques for predicting the personality from text. A person may typically have more than one personality trait, but current systems are not able to identify which is the most prominent and less significant trait from the multiple personality traits identified.

The limitation of the current systems is how to correlate the information on the multiple personality traits that have been identified from the text from different sources of data. This limitation stems from the fact that the current systems do not go into deep levels like analysis of texts based on different topics and correlating them based on the prominent personality traits. Further, current systems do not know how to automate the above process in an efficient manner according to need and for the benefit of different businesses.

Currently, computer systems have separate systems for facial recognition, and speech recognition. These separate systems work independently of each other and provide separate output information which is used independently. For emotion recognition and modelling of user characteristics, simply using one system may not provide enough contextual information to accurately model the emotions or behavior characteristics of the user.

In the field of predicting personality categories based on artificial neural networks, studies to predict the speaker's personality by applying personality models used in the field of psychology such as Big-Five or MBTI are being actively conducted. There is still a lack of research conducted on methods for predicting and recognizing. For example, in the Big-Five model, in utterances that show neuroticism personality traits, antagonistic personality traits are often expressed together.

In addition, there is a characteristic that the speaker's personality traits appear prominently when the speaker expresses his or her emotions. So far, no research has been conducted on using information related to the speaker's emotions in predicting personality traits.

The US Patent Publication number US2019/0341025A1 describes an integrated understanding of user characteristics by multimodal processing. The system and method for multimodal classification of user characteristics is described. The method comprises receiving audio and other inputs, extracting fundamental frequency information from the audio input, extracting other feature information from the video input, classifying the fundamental frequency information, textual information, and video feature information using the multimodal neural network.

The U.S. Pat. No. 10,079,029B2 discloses a system for Generating communicative behaviors for anthropomorphic virtual agents based on the user's affect. The Systems and methods for automatically generating at least one of facial expressions, body gestures, vocal expressions, or verbal expressions for a virtual agent based on emotion, mood, and/or personality of a user and/or the virtual agent are provided. Systems and method for determining a user's emotion, mood and/or personality are also provided.

The international patent application number WO2021/153830A1 reveals a method for recognizing personality from uttered conversation, and a system for same. The system recognizes personality from an uttered conversation, and a method for the same. According to an embodiment, a system, implemented with a computer, for recognizing personality from an uttered conversation comprises at least one processor for executing computer-readable instructions, wherein the at least one processor includes: a pre-processing unit which isolates, from an input conversation, a target utterance from which personality is to be recognized, as well as an utterer that has uttered the target utterance; an emotion information prediction unit which predicts the emotion of the utterer that has uttered the target utterance, on the basis of the target utterance; an utterance personality prediction unit which predicts the category of the personality of the utterer on the basis of the target utterance; and an emotion-personality dependence analysis unit which analyzes the dependence between the predicted emotion and the predicted personality category to recognize the personality of the utterer.

The US patent number U.S. Pat. No. 8,825,764B2 discloses a process of determining user personality characteristics from social networking system communications and characteristics. The social networking system obtains linguistic data from a user's text communications on the social networking system. For example, occurrences of words in various types of communications by the user in the social networking system are determined. The linguistic data and non-linguistic data associated with the user are used in a trained model to predict one or more personality characteristics for the user. The inferred personality characteristics are stored in connection with the user's profile, and may be used for targeting, ranking, selecting versions of products, and various other purposes.

The U.S. Pat. No. 10,855,712B2 describes a detection of anomalies in a time series using values of a different time series. In some implementations, sequences of time series values determined from machine data are obtained. Each sequence corresponds to a respective time series. A plurality of predictive models is generated for a first time series from the sequences of time series values. Each predictive model is to generate predicted values associated with the first time series using values of a second time series.

For each of the plurality of predictive models, an error is determined between the corresponding predicted values and values associated with the first time series. A predictive model is selected for anomaly detection based on the determined error of the predictive model.

Transmission is caused by an indication of an anomaly detected using the selected predictive model.

Human perception of personality traits, moral inclinations, and risk-taking behavior is often inferred from facial expressions. Traditional psychological research has established correlations between facial expressions and personality traits, as well as between facial reactions and moral decision-making. However, relying on human judgment is prone to bias and lacks scalability for large-scale analysis.

Existing methodologies primarily focus on textual data for personality prediction, using social media activity, speech analysis, and survey-based assessments. While facial emotion recognition (FER) has been applied to identify transient emotional states, its potential to predict stable personality traits and moral values using machine learning remains underexplored. Prior art includes:
Personality prediction from browsing behavior (Kyriaki Kalimeri, Mariano G. Beiró, et al.)
Facial expression-based prediction of FFI personality traits using hardcoded PANAS models
ChaLearn “Looking at People” Challenge for FFI prediction from facial expressions personality through face recognition methods, such as AU Patent AU2021100211A4

These prior works either rely on textual data, use hardcoded models, or lack deep learning-based automated systems capable of multi-domain personality and moral value prediction.

However, all the above cited prior art do not teach the same subject matter being taught in the present inventions.

It is against this background that there is a need to develop and avail a user-friendly process of predicting personality and morals through facial emotion recognition. Thus, there is a need in the art, for a system that can utilize multiple modes of input to predict user emotion and/or moral characteristics.

### OBJECTS OF THE INVENTIONS

The primary objective of the present inventions is to provide an AI-powered system for predicting personality traits, moral values, and risk-taking behavior through deep learning-based FER. Specifically, the inventions aim to:
1. Apply deep learning models to extract emotional features from facial expressions and use them for personality trait inference.
2. Integrate multi-domain psychological assessments, including: —Five-Factor Inventory (FFI/OCEAN model) —DOSPERT risk-taking scale —Haidt's Moral Foundations —Schwartz Personal Values
3. Use neural networks to map facial expressions to underlying psychological constructs.
4. Optimize video-based stimulus-response data collection for improved prediction accuracy.
5. Achieve high predictive accuracy (≥86%) using ensemble learning techniques, such as gradient boosting.

### SUMMARY OF THE INVENTIONS

In one aspect, a non-transitory machine readable instructions for execution on a processor, the non-transitory machine readable instructions directing the processor to display a video from a memory on a display interface connected to the processor, capture a frame of a facial image of a user with a camera connected to the processor, and storing the frame in the memory, determine an emotion in the frame with a facial emotion recognition software, store the emotion in the memory, when the video is completed, average the emotions stored in the memory and store the average in a vector stored in the memory, repeat for a plurality of videos, execute a machine learning model to convert the vector into a list of personality traits, and display the personality traits on the display interface.

The non-transitory machine readable instructions for execution on the processor where the plurality of videos are emotionally provoking movie snippets (102). The non-transitory machine readable instructions for execution on the processor where the facial emotion recognition software is ResNet-32. The non-transitory machine readable instructions for execution on the processor as in claim 1, where the machine learning model is trained using personality surveys (101). The non-transitory machine readable instructions for execution on the processor where the personality surveys (101) include a Neuroticism, Extraversion, Openness Five Factors (NEO FFI) personality inventory. The non-transitory machine readable instructions for execution on the processor where the personality surveys (101) include a Haidt moral foundations test.

In one aspect, a method includes displaying a video stored in a memory on a display interface, the display interface and the memory connected to a processor, capturing a frame of a facial image of a user with a camera connected to the processor and storing the frame in the memory, determining an emotion in the frame with a facial emotion recognition software, storing the emotion in the memory, when the video is completed, average the emotions stored in the memory and store the average in a vector in the memory, repeat for a plurality of videos, execute a machine learning model to convert the vector into a list of personality traits, and display the personality traits on the display interface.

The method may also include where the plurality of videos are emotionally provoking movie snippets (102). The method may also include where the facial emotion recognition software is ResNet-32. The method may also include where the facial emotion recognition software is EfficientNet. The method may also include where the machine learning model is trained using personality surveys (101). The method may also include where the personality surveys (101) include a Schwartz personal value system. The method may also include where the personality surveys (101) include domain-specific risk-taking scale.

In one aspect, an apparatus includes a processor, a memory connected to the processor, the memory includes a video, a display interface connected to the processor, a camera connected to the processor, where the display interface displays the video from the memory, where the camera captures a plurality of frames of facial images of a user and stores the plurality of frames in the memory, where the processor executes a facial emotion recognition software to determine an average emotion in the plurality of frames and stores the average emotion for the video in a vector stored in the memory, where the processor repeats the display of the video, the capture of the plurality of frames, execution of the facial emotion recognition software, and the storage of the average emotion in the vector for a plurality of videos, where the processor executes a machine learning model to convert the vector into a list of personality traits, and where the display interface displays the personality traits.

The apparatus may also include the plurality of videos are emotionally provoking movie snippets (102). The apparatus may also include where the facial emotion recognition software is a convolutional neural network. The apparatus may also include where the machine learning model is trained using personality surveys (101). The apparatus may also include where the convolutional neural network uses a ResNet-34 architecture. The apparatus may also include where the personality surveys (101) include the Neuroticism, Extraversion, Openness Five Factors (NEO FFI) personality inventory. The apparatus may also include where the personality surveys (101) include a Schwartz personal value system. Other technical features may be readily apparent to one skilled in the art from the following figures, descriptions, and claims.

### BRIEF DESCRIPTION OF FIGURES

FIG. 1 represents a setup of our system with video website and four online surveys.

FIG. 2A represents the relationships between videos, emotions, and personality (top), and between emotions and individual traits (bottom).

FIG. 2B illustrates an aspect of the subject matter in accordance with one embodiment.

FIG. 3 represents a feature importance for predicting conservation.

FIG. 4 represents a feature importance for predicting authority/respect.

FIG. 5 represents a feature importance for predicting conscientiousness.

FIG. 6 represents a feature for predicting health likelihood.

FIG. 7 represents feature importance for predicting transcendence.

FIG. 8 represents feature importance for predicting fairness/reciprocity.

FIG. 9 represents feature importance for predicting harm/care.

FIG. 10 represents feature importance for predicting in-group loyalty.

FIG. 11 represents feature importance for predicting purity/sanctity.

FIG. 12 represents feature importance for predicting agreeableness.

FIG. 13 represents feature importance for predicting extraversion.

FIG. 14 represents feature importance for predicting neuroticism.

FIG. 15 represents feature importance for predicting openness.

FIG. 16 represents feature importance for predicting ethical likelihood.

FIG. 17 represents feature importance for predicting ethical perceived.

FIG. 18 represents feature importance for predicting financial likelihood.

FIG. 19 represents feature importance for predicting financial perceived.

FIG. 20 represents feature importance for predicting health perceived.

FIG. 21 represents feature importance for predicting recreational likelihood.

FIG. 22 represents feature importance for predicting recreational perceived.

FIG. 23 represents feature importance for predicting social likelihood.

FIG. 24 represents feature importance for predicting social perceived.

FIG. 25 illustrates a block diagram of a possible hardware implementation.

FIG. 26 shows a block diagram for creating the machine learning model.

FIG. 27 shows a block diagram for predicting the personality of a user.

### DETAILED DESCRIPTION OF THE INVENTIONS

The following description is presented to enable any person skilled in the art to make and use the inventions as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another.

Disclosed in the present inventions is a system and methods of predicting personality and morals through facial emotion recognition. The inventions introduces a machine learning system that predicts personality characteristics of individuals on the basis of their facial expression.

In one preferred embodiment, the inventions do so by tracking the emotional response of the individual's face through facial emotion recognition (FER) while watching a series of 15 short videos of different genres. To calibrate the system, inventors invited 85 people to watch the videos, while their emotional responses were analysed through their facial expression. At the same time, these individuals also took four well-validated surveys of personality characteristics and moral values: the revised NEO FFI personality inventory, the Haidt moral foundations test, the Schwartz personal value system, and the domain-specific risk-taking scale (DOSPERT).

In another preferred embodiment, the inventions disclose a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; In another preferred embodiment, the inventions reveal that personality characteristics and moral values of an individual can be predicted through their emotional response to the videos as shown in their face, with an accuracy of up to 86% using gradient-boosted trees.

In another preferred embodiment, the inventions reveal that different personality characteristics are better predicted by different videos, in other words, there is no single video that will provide accurate predictions for all personality characteristics, but it is the response to the mix of different videos that allows for accurate prediction.

In another embodiment, the inventions avail a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; an emotion information prediction unit for predicting a personality of a target based on the facial emotion recognition. a facial emotion recognition personality predicting unit for predicting a personality category of the target based on the target facial emotion recognition; and an emotion-personality dependency analysis unit for recognizing the target's personality by analyzing the dependence between the predicted emotion and the predicted personality category

The teachings of the present inventions can be readily understood by considering the following detailed description in conjunction with the accompanying drawings.

The inventions introduce a deep learning-based system that predicts personality traits, moral values, and risk-taking behaviors based on an individual's facial emotional responses to curated video stimuli.

### Methodology

Facial Emotion Recognition (FER) Pipeline: The system captures micro-expressions and emotional reactions through convolutional neural networks (CNNs), including architectures like ResNet-34 (ResNet-32 or other residual neural networks with different numbers of layers) and EfficientNet, applied to video frames.
Data Collection & Calibration: Participants watch 15 short videos of diverse emotional intensity while their facial expressions are continuously analyzed.
Ground Truth Validation: Participants complete validated psychological surveys:
NEO-FFI (Openness, Conscientiousness, Extraversion, Agreeableness, Neuroticism)
Haidt's Moral Foundations (Care, Fairness, Loyalty, Authority, Sanctity)
Schwartz Personal Values (Conservation, Openness to Change, Self-Enhancement, Self-Transcendence)
DOSPERT Risk-Taking Scale (Ethical, Financial, Recreational, Health, Social risk domains)

### Machine Learning Models:

Gradient-boosted decision trees (XGBoost, LightGBM)
Transformer-based emotion embedding models (BERT-based emotion prediction models)
Ensemble deep learning models to refine prediction accuracy

### Predictive Accuracy:

The system achieves up to 86% accuracy in predicting personality and moral values.
Uses Shapley Additive Explanations (SHAP) for feature importance analysis.

Can we really “read the mind in the eyes”? Moreover, can AI assist us in this task?

The present inventions attempt to answer these two questions by introducing a machine learning system that predicts personality characteristics of individuals on the basis of their face. It does so by tracking the emotional response of the individual's face through facial emotion recognition (FER) while watching a series of 15 short videos of different genres. To calibrate the system, the inventor invited 85 people to watch the videos, while their emotional responses were analyzed through their facial expression. At the same time, these individuals also took four well-validated surveys of personality characteristics and moral values: the revised NEO FFI personality inventory, the Haidt moral foundations test, the Schwartz personal value system, and the domain-specific risk-taking scale (DOSPERT). The NEO-FFI-3 is a 60-item version of the NEO-PI-3 that provides a quick, reliable, and accurate measure of the five domains of personality (Neuroticism, Extraversion, Openness, Agreeableness, and Conscientiousness). All updates made in the NEO-PI-3 are reflected in this instrument.

In a preferred embodiment, the inventions reveal that personality characteristics and moral values of an individual can be predicted through their emotional response to the videos as shown in their face, with an accuracy of up to 86% using gradient-boosted trees. We also found that different personality characteristics are better predicted by different videos, in other words, there is no single video that will provide accurate predictions for all personality characteristics, but it is the response to the mix of different videos that allows for accurate prediction.

### Emotional Response Shows Individual Value System

On the basis of their moral values, humans experience or show different emotions in response to an external stimulus. Emotional actions triggered through moral values are called “moral affect” [12]. Moral affect-such as shame, guilt, and embarrassment is linked to moral behavior, leading to prohibitions against behavior that is likely to have negative consequences for the well-being of others [13]. For instance, on the basis of the personal value system, an individual might have shown a different emotional reaction when President Trump was announcing the construction of a wall to keep out asylum seekers from Mexico [14]. Both philosophers [14] and psychologists [2] have investigated this link between morals and emotions.

In order to experience that something is wrong, one needs to have a feeling of disapproval towards it [14]. To measure this feeling of disapproval, thus far, technologies such as tracking the hormone level in blood or saliva have been used. For instance, it has been shown that the hormone level in saliva of homosexual and heterosexual men, when shown

pictures of two men kissing, is radically different [15]. The researchers showed homosexual and heterosexual men in Utah pictures of same-sex public display of affection, plus disgusting images, such as a bucket of maggots. They used the link between disgust and prejudice, which has been shown to be capable of eliciting responses from the sympathetic nervous system, one of the body's major stress systems [16]. Salivary alpha-amylase is considered a biomarker of the sympathetic nervous system that is especially responsive to inductions of disgust.

The researchers found that the difference in salivary alpha-amylase explained the degree of sexual prejudice against homosexuality among their test subjects, similar to their disgust about a bucket of maggots. In other words, their emotional response, measured through salivary alpha-amylase, indicated their moral values. Instead of measuring negative (and positive) emotions through the saliva, in our research, we measured it through face emotion recognition, maintaining the existence of a similar link between emotional response and moral values.

### Reading Personality Attributes from Facial Characteristics

Studying the relationship between facial and personality characteristics has a long history going back to antiquity. The book “Physiognomics”, discussing the relationship between facial appearance and character, was written 300 BC in Aristotle's name, but is today attributed to a different author by most researchers. Swiss poet, writer, philosopher, physiognomist, and theologian Johann Caspar Lavater published between 1775 and 1778 his magnum opus on physiognomy, “Physiognomische Fragmente zur Beforderung der Menschenkenntnis und Menschenliebe” (Physiognomic fragments to promote knowledge of

human nature and human love) [17], which cataloged leaders and ordinary men (there were very few pictures of women) of his time by their facial shape, or what he called their “lines of countenance”. Lavater even invented an apparatus for taking facial silhouettes to quickly capture the characteristics of a face, and thus the personality of the person.

Later, statistician Francis Galton tried to define physiognomic characteristics of health, beauty, and criminology by creating composites through overlaying pictures of archetypical faces [18]. Italian criminologist and scientist Cesare Lombroso continued this work by defining facial measures of degeneracy and insanity including facial angles, “abnormalities” in bone structure, and volumes of brain fluid [19]. For the better part of the 20th century, scientists derogatively titled physiognomics as “pseudoscience”. This changed towards the end of the 20th century. While early physiognomists from Aristotle to Lombroso tried to develop manually assembled frameworks, AI and deep learning have given a huge boost to this emerging field.

Recently, physiognomics has been experiencing renewed interest by researchers, particularly by comparing facial width to height ratio with personality. The theory of “facial width to height ratio” (fWHR) posits that men with higher “facial width to height ratio”, that means with broader, rounder faces, are more aggressive, while men with thinner faces are more trustworthy [20-23]. Recognizing these features automatically through facial emotion recognition has come a long way since the early days of the facial action coding system, thanks to recent advances in AI and deep learning. A large amount of research has addressed the issue of recognizing personality characteristics from facial attributes. For instance, ChaLearn “Looking at People First Impression Challenge” released a dataset with 10,000 15 s videos with faces (https://chalearnlap.cvc.uab.cat/dataset/20/description/, accessed on 21 Dec. 2021) [24], asking participants in the challenge to identify the FFI personality characteristics [8] of the person on the video, and their age, ethnicity, and gender attributes [25].The problem with this dataset is that the personality attributes had been added by Amazon Mechanical Turkers, which sometimes leads to a biased ground truth, as it is based on guesswork by humans (the turkers). As was mentioned in the introduction, it has been shown by other researchers that accuracy of human labelers in recognizing emotions is only incrementally better than guesswork at slightly below 50 percent [2]. Nevertheless, the winners of the ChaLearn challenge have achieved impressive accuracy on this pre-labeled dataset to

correctly predict the FFI personality characteristics at over 91% [26]. However, it would be better to have true ground truth on the personality characteristics of the subjects on the video. In another project using Facebook likes, where ground truth was available, the researchers showed that the computer was actually better in recognizing personality characteristics than work colleagues, who reached only 27% accuracy, while the computer achieved 56% accuracy [3]; spouses were the most accurate at 58%.

The personality characteristics had been collected from 86,220 users through a personality survey on Facebook and were predicted through Facebook likes using regression. Earlier work has used facial expression of the viewer to measure the quality of a video [27-29]. We extend this work to not only measure the degree of enjoyment of the viewer, but the personality characteristics and moral values of the viewer-motivated by the insight that facial expressions will mirror moral values-combining face emotion recognition with ground truth obtained directly from surveys taken by the individual.

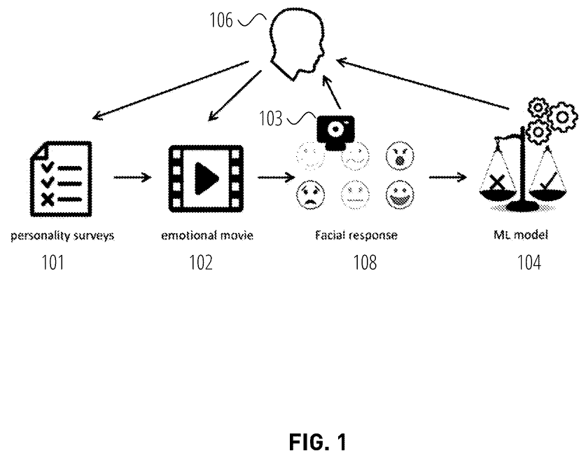

In several embodiments of the present inventions according to FIG. 1 to FIG. 27, the method teaches about human personality and morals and in particular to a system and methods of predicting personality and morals through facial emotion recognition.

FIG. 1 represents a setup of our system with video website and four online surveys of the inventions. In this embodiment, the user fills out four morality and personality surveys 101. Then the user views 15 emotionally provoking movie snippets 102 which provoke a facial response to the movie snippets. The facial response is recorded with Webcam 103, 1116. The machine learning model trained with emotions from movies and morals from surveys automatically predicts morals at the machine learning model 104 step.

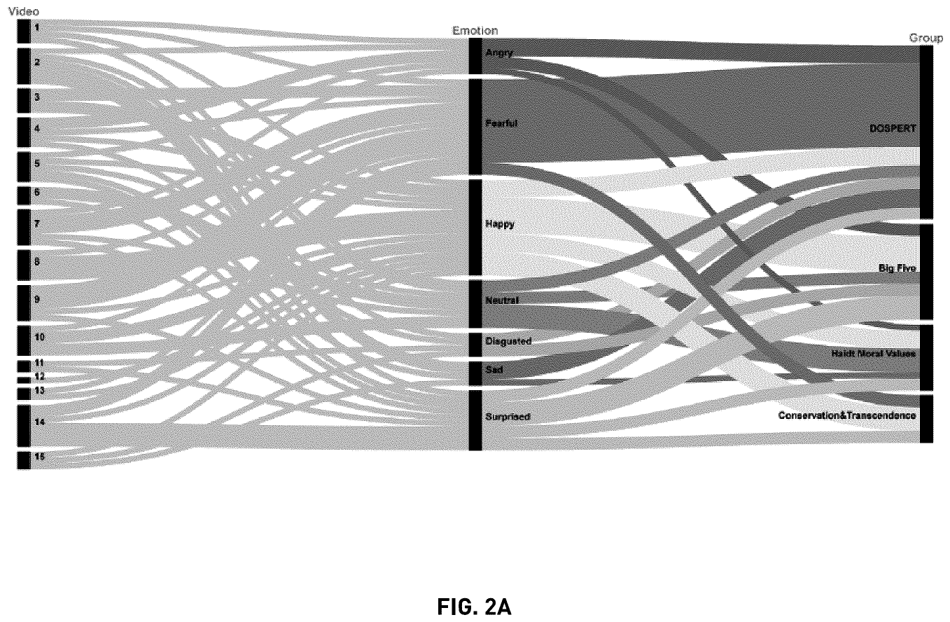

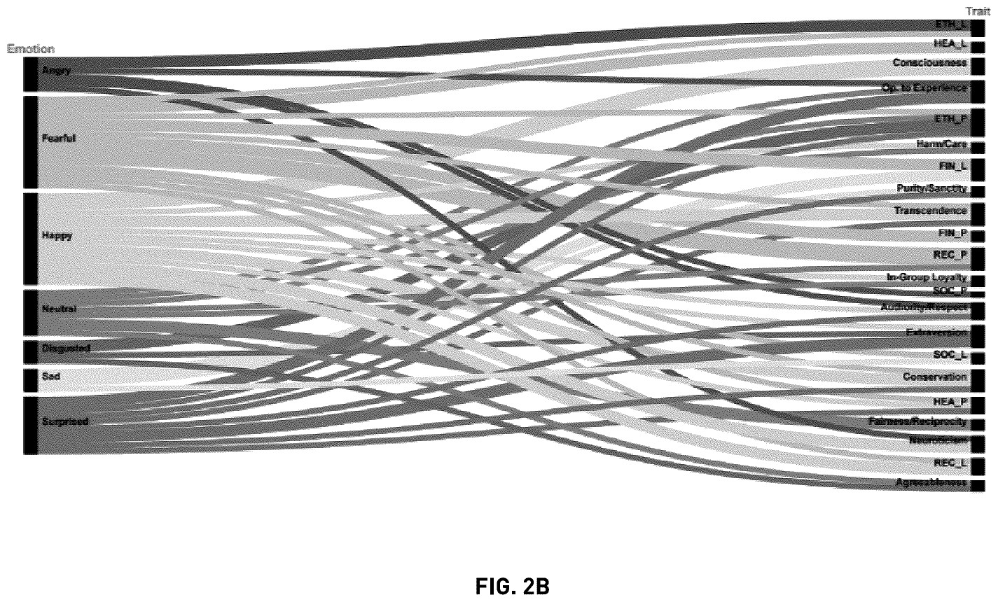

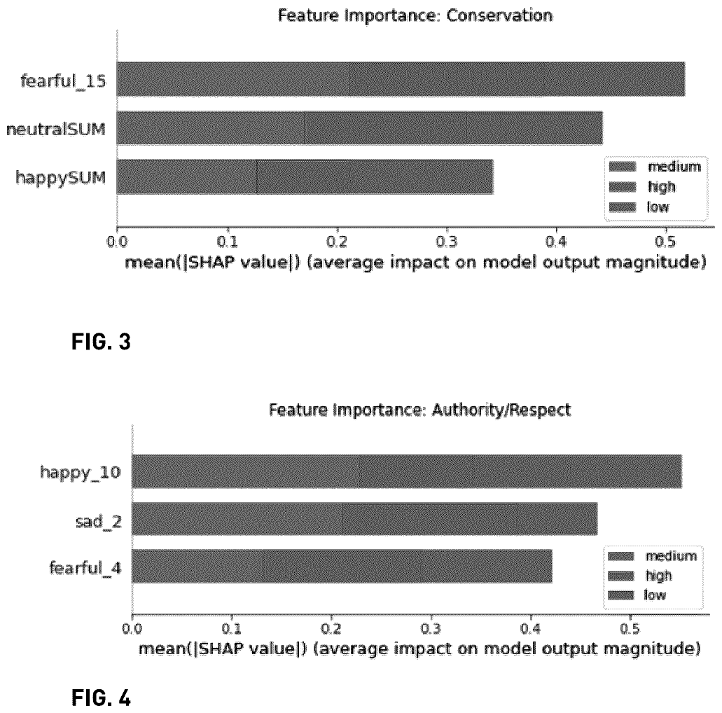

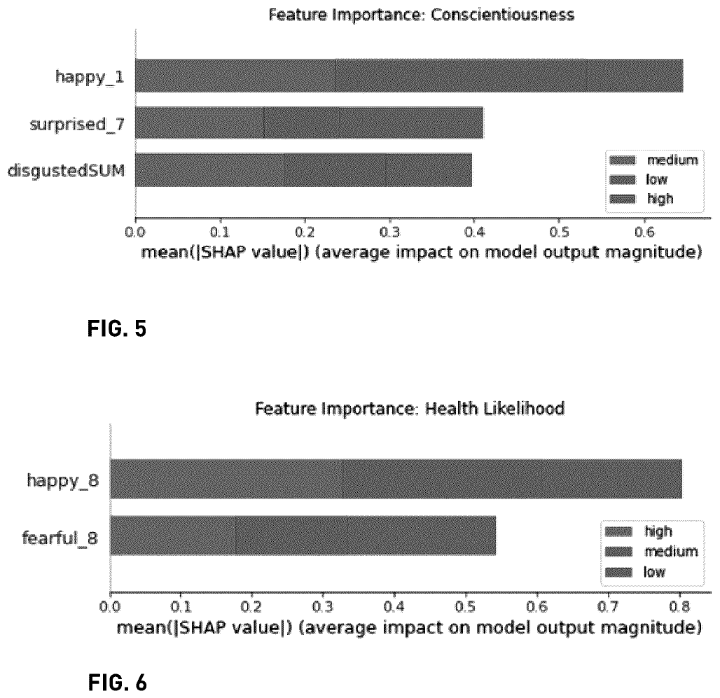

FIG. 2A represents alluvial diagrams illustrating the significant relationships between videos, emotions, and personality, and FIG. 2B represents alluvial diagrams illustrating the significant relationships between emotions and individual traits. FIG. 3 represents a feature importance for predicting conservation while FIG. 4 represents a feature importance for predicting authority/respect. In FIG. 5, the inventions show a feature importance for predicting conscientiousness. In FIG. 6, the inventions teach of a feature for predicting health likelihood.

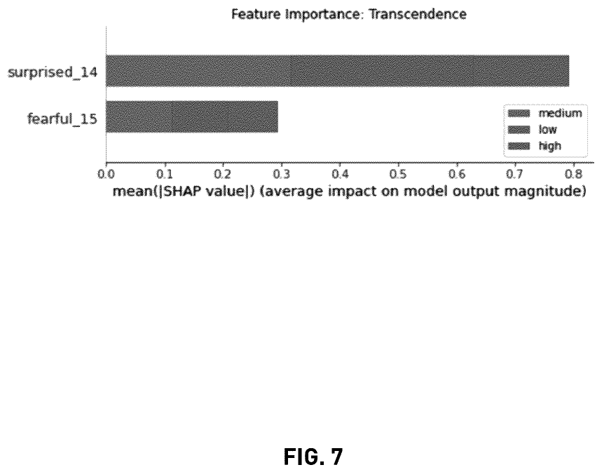

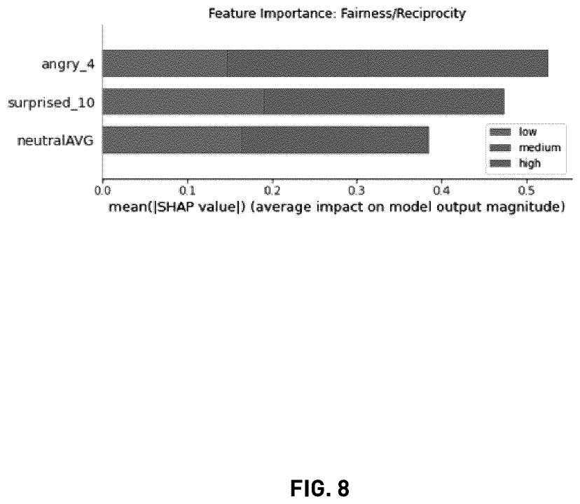

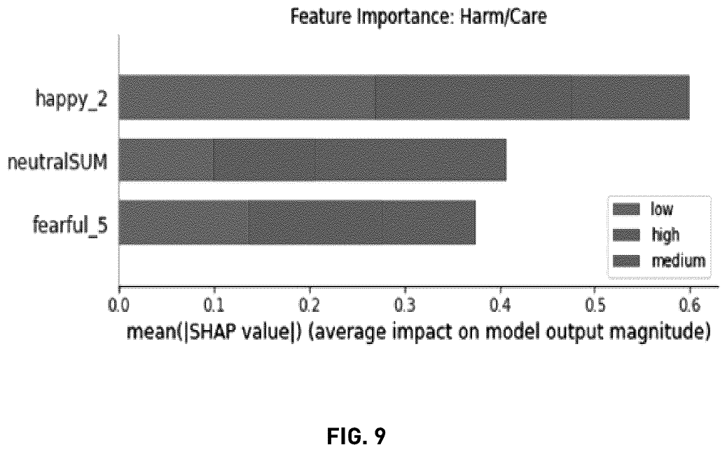

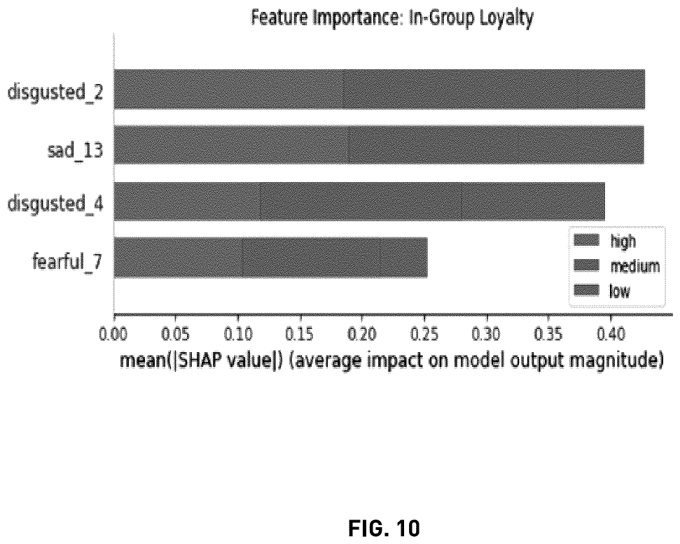

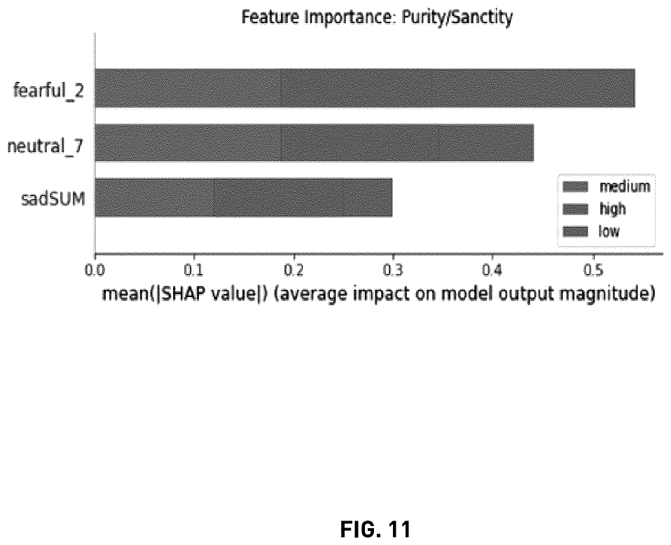

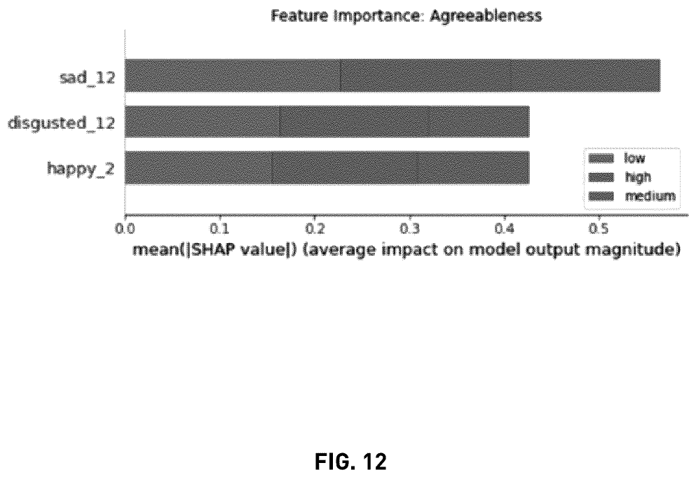

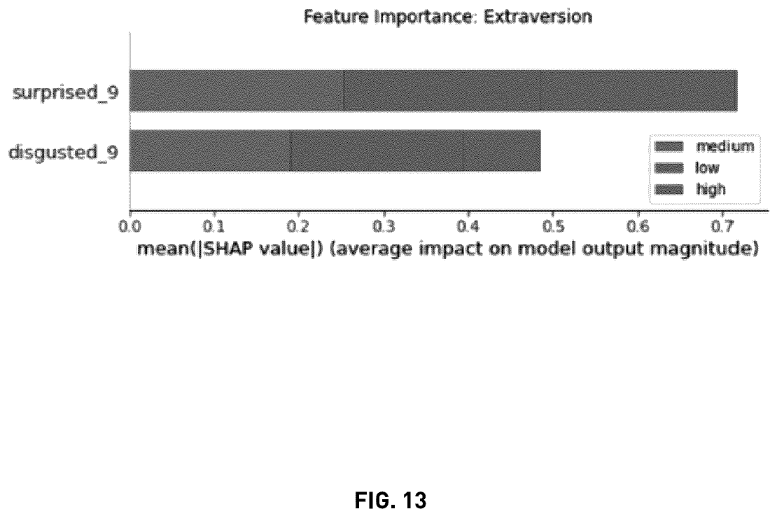

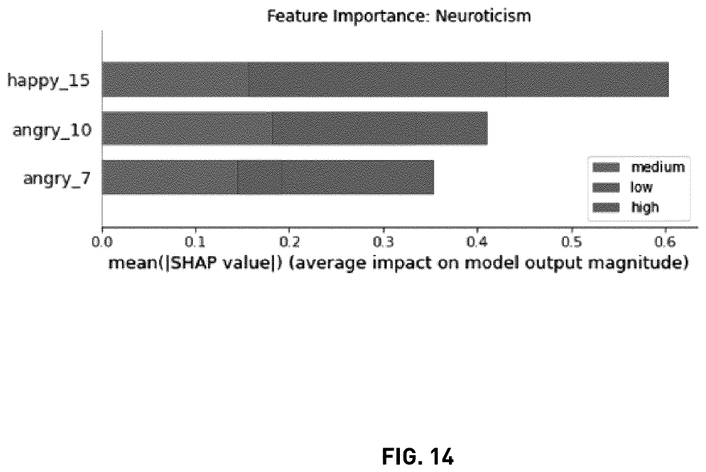

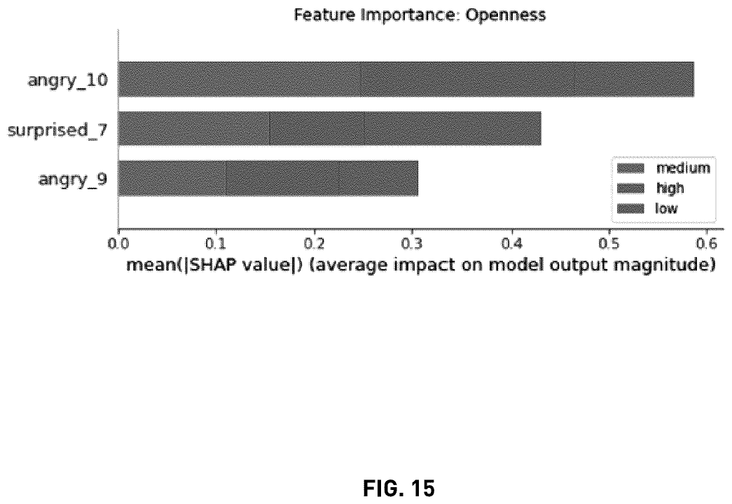

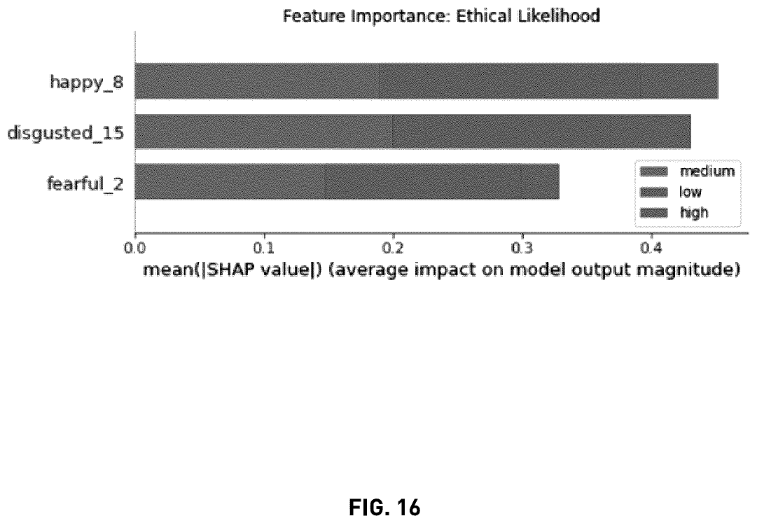

In another set of embodiment, FIG. 7 represents feature importance for predicting transcendence. FIG. 8 represents feature importance for predicting fairness/reciprocity while FIG. 9 represents feature importance for predicting harm/care. FIG. 10 represents feature importance for predicting in-group loyalty. FIG. 11 represents feature importance for predicting purity/sanctity. Whereas FIG. 12 represents feature importance for predicting agreeableness, FIG. 13 represents feature importance for predicting extraversion. In FIG. 14 represents feature importance for predicting neuroticism. FIG. 15 represents feature importance for predicting openness. FIG. 16 represents feature importance for predicting ethical likelihood.

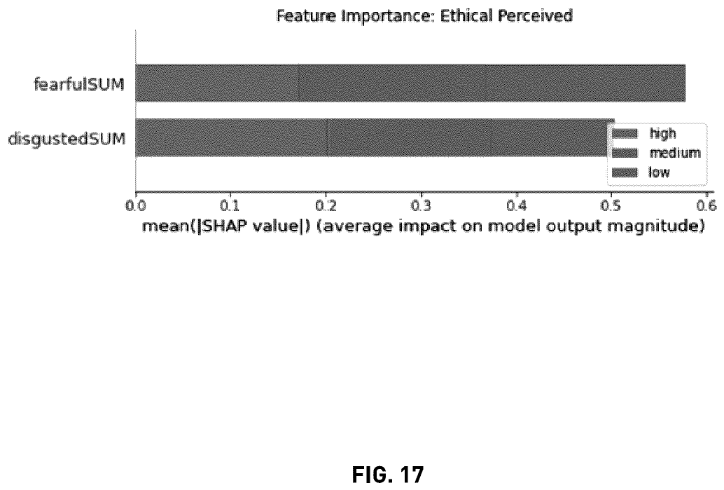

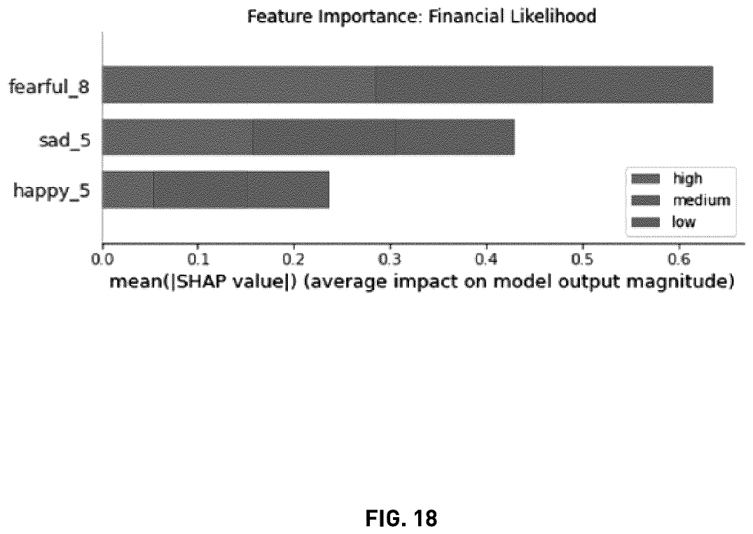

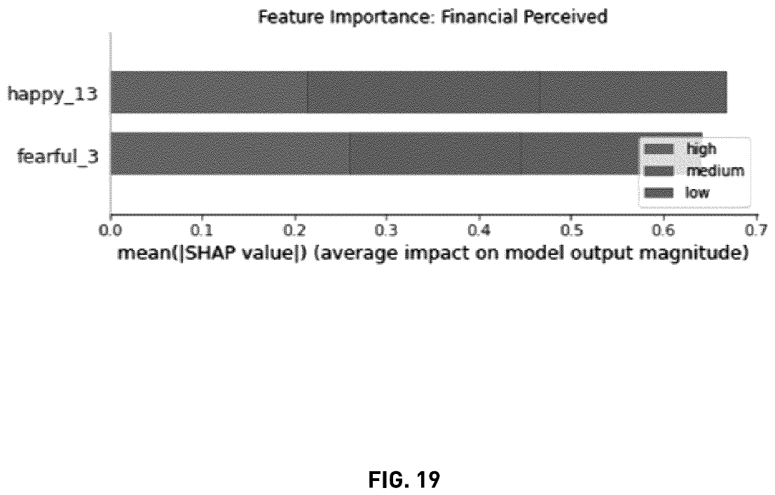

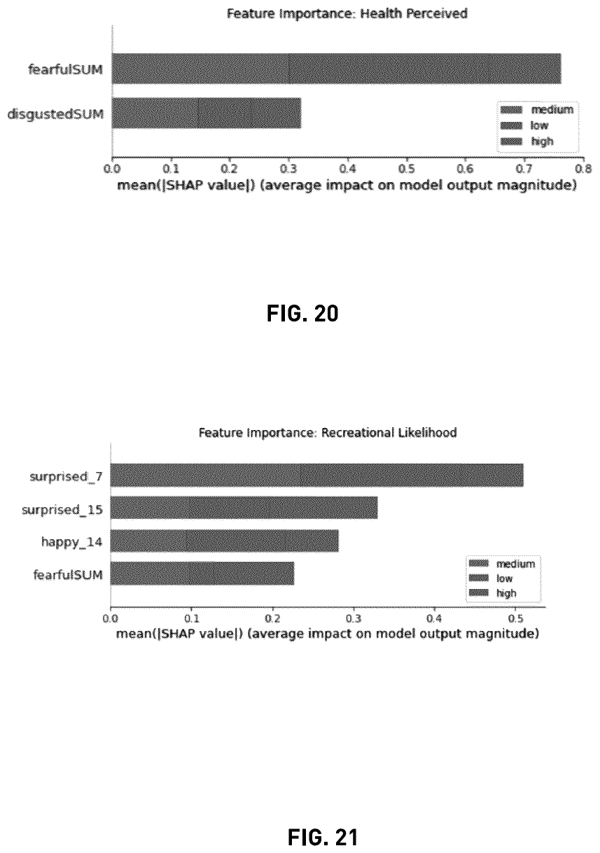

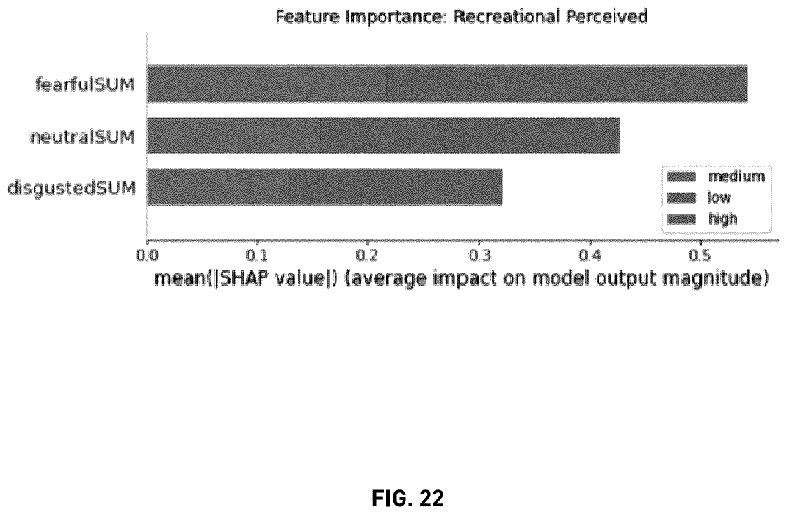

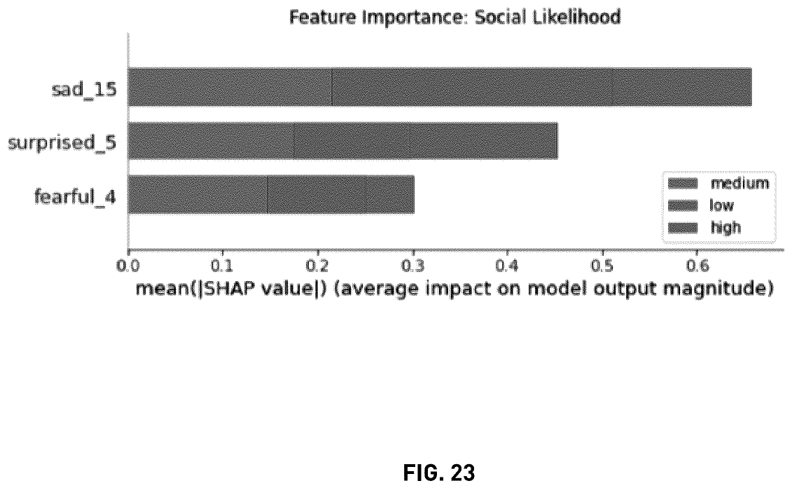

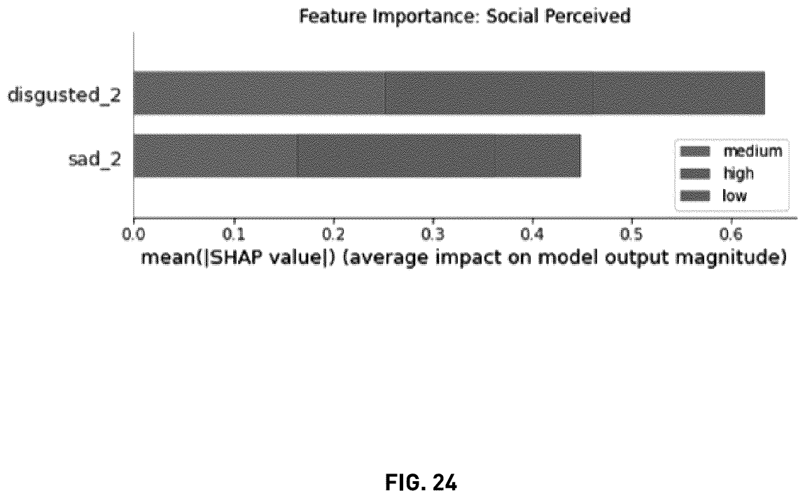

Further, FIG. 17 represents feature importance for predicting ethical perceived by the inventions. While FIG. 18 represents feature importance for predicting financial likelihood, FIG. 19 represents feature importance for predicting financial perceived. FIG. 20 represents feature importance for predicting health perceived. FIG. 21 represents feature importance for predicting recreational likelihood. FIG. 22 represents feature importance for predicting recreational perceived. While FIG. 23 represents feature importance for predicting social likelihood, FIG. 24 represents feature importance for predicting social perceived. Further, the inventions avail Table 1 showing a list of 15 movie snippets.

TABLE 1
List of 15 movie snippets.

| Video | |
|---|---|
| Number | Short Description |
| 1 | puppies—cute puppies running |
| 2 | avocado—a toddler holding an avocado |
| 3 | condom ad—child throwing a tantrum in a supermarket |
| 4 | runner—competitive runners supporting a girl from another team |
| | over the finish line |
| 5 | maggot—a guy eating a maggot |
| 6 | soldier—soldiers at battle |
| 7 | Trump—Donald Trump talking about the Mexican mass |
| | migration |
| 8 | mountain bike—mountain biker on daring ride down a rock |
| | bridge |
| 9 | roof bike—guy biking on top of a skyscraper |
| 10 | roof run—guy balancing and almost falling on top of skyscraper |
| 11 | racoon—man beating racoon to death |
| 12 | abandoned—social worker feeding a starved abandoned black |
| | toddler |
| 13 | waste—residents collecting electronic waste in the slums of |
| | Accra |
| 14 | dog—sad dog on the gravestone of his master, missing him |
| 15 | monster—man discovering an invisible monster through the |
| | picture on his instant camera |

Table 2 that shows descriptive statistics of individual traits.

TABLE 2
Descriptive statistics of individual traits.

| Variable | M | SD | Min | Max |
|---|---|---|---|---|
| Agreeableness | 0.64 | 0.08 | 0.47 | 0.83 |
| Conscientiousness | 0.69 | 0.06 | 0.52 | 0.83 |
| Neuroticism | 0.54 | 0.09 | 0.33 | 0.73 |
| Extraversion | 0.67 | 0.07 | 0.50 | 0.83 |
| Openness to experience | 0.61 | 0.06 | 0.48 | 0.78 |
| ETH_L | 2.56 | 1.31 | 1.50 | 7.33 |
| ETH_P | 4.55 | 1.23 | 1.83 | 8.83 |
| FIN_L | 3.25 | 1.39 | 1.00 | 8.33 |
| FIN_P | 4.72 | 1.34 | 1 | 9 |
| HEA_L | 3.33 | 1.10 | 1.17 | 6.33 |
| HEA_P | 4.81 | 1.02 | 1.50 | 7.17 |
| SOC_L | 5.58 | 1.07 | 3.50 | 9.67 |
| SOC_P | 2.72 | 1.12 | 1.17 | 6.67 |
| REC_L | 4.19 | 1.35 | 1.50 | 7.33 |
| REC_P | 3.99 | 1.15 | 1.83 | 7 |
| Conservation | 0.77 | 0.74 | −0.62 | 3.54 |
| Transcendence | −1.20 | 0.70 | −2.87 | 0.70 |
| Harm/care | 22.36 | 3.93 | 12 | 29 |
| Fairness/reciprocity | 22.13 | 4.08 | 7 | 30 |
| In-group loyalty | 16.54 | 4.30 | 6 | 25 |
| Authority/respect | 13.57 | 4.45 | 3 | 22 |
| Purity/sanctity | 11.93 | 4.68 | 0 | 20 |

ETH_L = ethical likelihood; ETH_P = ethical perceived; FIN_L = financial likelihood; FIN_P = financial perceived; HEA_L = health likelihood; HEA_P = health perceived; SOC_L = social likelihood; SOC_P = social perceived; REC_L = recreational likelihood; REC_P = recreational perceived.

Table 3 that demonstrates regression models for the Big Five personality traits.

TABLE 3
Regressive models for the Big Five personality traits.

| Predictor/Dependent | Neuroticism | Extraversion | Openness to Experience | Agreeableness | Consciousness |
|---|---|---|---|---|---|
| Angry 2 | | | 4.922 **** | | |
| Angry 7 | 0.665 * | | | | |
| Disgusted 4 | | 0.297 * | | | |
| Disgusted 11 | | | | 0.547 ** | |
| Happy 1 | | | | | −0.067 *** |
| Happy 8 | | 0.070 * | | | 0.149 *** |
| Happy 9 | | | | | −0.104 ** |
| Happy 13 | −0.398 * | | | | |
| Happy 15 | 0.226 ** | | | | |
| Neutral 1 | | | 0.038 * | | |
| Neutral 10 | | | | 0.062 * | |
| Surprised 7 | | | −2.735 *** | | |
| Surprised 9 | | 0.499 ** | | | |
| Surprised 11 | | | 0.352 * | | |
| Surprised 14 | | −3.049 ** | | | |
| Constant | 0.518 *** | 0.659 *** | 0.582 *** | 0.591 *** | 0.700 *** |
| Adjusted R² | 0.184 | 0.263 | 0.257 | 0.131 | 0.198 |
| N | 80 | 80 | 80 | 80 | 80 |

* p < 0.05;
** p < 0.01;
*** p < 0.001.

Table 4 for regression models for the DOSPERT scale values.

TABLE 4
Regression models for the DOSPERT scale values.

| [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|
| [symbol] | [symbol] | | | | | | | | | |
| [symbol] | | | | | | | | [symbol] | | |
| [symbol] | [symbol] | | | | | | | | | |
| [symbol] | | [symbol] | | | | | | | | |
| [symbol] | | [symbol] | | | | | | | | |
| [symbol] | | | | | [symbol] | | | | | |
| [symbol] | | | | [symbol] | | | | | | [symbol] |
| [symbol] | | | | | | | [symbol] | | | |
| [symbol] | | [symbol] | | | [symbol] | [symbol] | | | | |
| [symbol] | | | [symbol] | | | | | | | |
| [symbol] | [symbol] | | [symbol] | | | | | | [symbol] | [symbol] |
| [symbol] | | | | [symbol] | | | | | | |
| [symbol] | | | | | | | | | | [symbol] |
| [symbol] | | | | | | [symbol] | | | | |
| [symbol] | | | | | | | | | [symbol] | |
| [symbol] | | | | | | | | | [symbol] | |
| [symbol] | | [symbol] | | | | | | | | |
| [symbol] | | | | | | | | | | [symbol] |
| [symbol] | | | [symbol] | | | | | | | |
| [symbol] | | | [symbol] | | | | | | | |
| [symbol] | | | | | | | [symbol] | | | |
| [symbol] | | | | | | [symbol] | | | | |
| [symbol] | | [symbol] | | | | | | | | |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |

[symbol]

[symbol]

indicates data missing or illegible when filed

Table 5 that demonstrates regression models for conservation and transcendence.

TABLE 5
Regression models for conversation and transcendence.

| Predictor/Dependent | Conservation | Transcendence |
|---|---|---|
| Happy 4 | | 1.078 ** |
| Happy 5 | −0.780 * | |
| Happy 8 | | −1.527 *** |
| Happy 10 | −0.829 ** | |
| Fearful 14 | −13.963 * | −15.090 ** |
| Surprised 2 | | 26.934 * |
| Surprised 14 | 44.428 *** | |
| Constant | 0.952 *** | −1.232 *** |
| Adjusted R² | 0.341 | 0.280 |
| N | 70 | 70 |

* p < 0.05;
** p < 0.01;
*** p < 0.001.

Table 6 for regression models for the Haidt moral values.

TABLE 6
Regression models for the Haidt moral values.

| Predictor/Dependent | Harm/Care | Fairness/Reciprocity | In-Group Loyalty | Authority/Respect | Purity/Sanctify |
|---|---|---|---|---|---|
| Angry 4 | | | | 71.456 * | |
| Happy 3 | −4.152 * | | −3.442 * | | |
| Happy 10 | | | | −5.078 ** | |
| Neutral 2 | −7.783 *** | | | | |
| Neutral 6 | | −7.897 *** | | | |
| Neutral 7 | | | −5.329 ** | | |
| Neutral 10 | | 3.391 * | | | |
| Sad 2 | | | | | 16.123 ** |
| Surprised 14 | | | | 143.987 * | 179.091 ** |
| Constant | 28.435 *** | 25.585 *** | 21.432 *** | 13.294 *** | 10.433 *** |
| Adjusted R² | 0.261 | 0.193 | 0.115 | 0.197 | 0.200 |
| N | 69 | 69 | 69 | 69 | 69 |

* p < 0.05;
** p < 0.01;
*** p < 0.001.

Table 7 showing accuracy of Xgboost models.

TABLE 7
Accuracy of XGboost models.

| Variable | Average Accuracy | Cohen's Kappa |
|---|---|---|
| Conservation | 73.3% | 0.57 |
| Transcendence | 71.4% | 0.53 |
| Authority/respect | 73.3% | 0.61 |
| Fairness/reciprocity | 73.3% | 0.56 |
| Harm/care | 86.7% | 0.79 |
| In-group loyalty | 80.0% | 0.66 |
| Purity/sanctity | 73.3% | 0.58 |
| Agreeableness | 81.3% | 0.71 |
| Conscientiousness | 78.9% | 0.69 |
| Extraversion | 72.2% | 0.58 |
| Neuroticism | 82.3% | 0.73 |
| Openness to experience | 72.2% | 0.58 |
| Ethical likelihood | 78.6% | 0.65 |
| Ethical perceived | 78.6% | 0.68 |
| Financial likelihood | 84.6% | 0.77 |
| Financial perceived | 78.6% | 0.68 |
| Health likelihood | 84.6% | 0.75 |
| Health perceived | 60.0% | 0.38 |
| Recreational likelihood | 71.4% | 0.59 |
| Recreational perceived | 86.7% | 0.80 |
| Social likelihood | 76.9% | 0.63 |
| Social perceived | 71.4% | 0.57 |

See Gloor, P. A.; Fronzetti Colladon, A.; Altuntas, E.; Cetinkaya, C.; Kaiser, M. F.; Ripperger, L.; Schaefer, T. Your Face Mirrors Your Deepest Beliefs—Predicting Personality and Morals through Facial Emotion Recognition. Future Internet 2022, 14, 5. https://doi.org/10.3390/fi14010005 (hereafter “Gloor”), Table A1, for Pearson's correlation coefficients, said paper incorporated herein by reference in its entirety.

### Methodology—Recording Emotions

Our approach extends existing systems by not only measuring video quality, but moral values and personality of the viewers, as it uses real ground truth on personality characteristics and moral values for prediction by asking the people whose faces are recorded while watching a sequence of 15 emotionally touching video segments to also fill out a series of personality characteristics tests.

For measuring facial emotions, the system consists of a website (facerecognition.galaxyadvisors.com) accessed on 21 Dec. 2021) where the participant watches a sequence of 15 videos (FIG. 1). Table 1 lists the 15 movie snippets, at a total length of 9 min 22 s, that are shown to users on the website, while the emotions of their faces are recorded after they have given informed consent that their anonymized emotions will be recorded; no video of the face is recorded.

The 15 video snippets show controversial scenes with the aim of generating a wide range of emotions in respondents [30]. We use the face-api.js tool (https://justadudewhohacks.github.io/face-api.js/docs/index.html, accessed on 21 Dec. 2021), which employs a convolutional neural network with a ResNet-34 architecture [31], to recognize the user's facial emotions in each frame (up to 30 times per second) of the user's Webcam 103, 1116. The tracked emotions are joy, sadness, anger, fear, surprise, and disgust [32]. In addition, a seventh emotion “neutral” was added, which greatly increases machine learning accuracy when none of the six Ekman emotions can be recognized.

### Measuring Personality and Morals of the Viewers

Our dependent variables are collected through four well-validated personality and moral values assessments. The user is asked on the same website where the videos are shown to fill out four online surveys for the revised NEO FFI personality inventory, the Haidt moral foundations test, the Schwartz personal value system, and the domain-specific risk-taking scale (DOSPERT). The OCEAN (Openness, Conscientiousness, Extroversion, Agreeability, Neuroticism) personality characteristics are measured with the Neo-FFI [8] survey. Risk-preference is measured by the Domain-Specific Risk-Taking (DOSPERT) survey [11], which assesses disposition to take risks in five specific domains of life (ethical, financial, recreational, health, and social). It measures both the willingness to take risks and the individual perception of an activity as risky.

Moral foundational values are measured with the Haidt moral foundations survey [9]. It measures the moral values of the respondent in five categories (care, fairness, loyalty, authority, and sanctity). In addition, the two dimensions of Conservation and Transcendence also are assessed through a survey [10,33]. The Schwartz values have been validated in many countries around the world [34].

### Results—Emotional Response Predicted Values

We found that all four dimension of a personality, FFI characteristics, DOSPERT risk taking, moral foundations, and Conservation and Transcendence (Schwartz values), can be predicted on the basis of the emotions shown while watching the 15 different video segments. Table 2 shows the descriptive statistics of our dependent variables for all four dimensions of a personality, listing the individual traits we mapped through psychometric tests.

In Gloor Table A1, the inventions show the Pearson's correlation coefficients of individual traits with the different emotions experienced while watching the videos. Neither commenting on each single association and its significance, nor investigating the possible reasons behind associations, is in the scope of this research. Rather it was intended to show the possibility of predicting individual traits, based on the differential emotional response of individuals exposed to the same set of stimuli, by considering automatically recognized emotions through artificial intelligence. The preliminary result of correlations—a suggested association between individual differences and people's emotional responses—is confirmed by the regression models presented in Tables 3-6. For each set of dependent variables, they show the best model, i.e., the optimal combination of predictors that can explain the larger proportion of variance. There was no evidence of collinearity problems (evaluated by calculating variance inflation factors). These regressions illustrate the predictability of personality characteristics and morals from facial expression of emotions using conventional statistical methods.

In general, we found that models for some traits-such as conservation, transcendence, and ethical and financial likelihood-had promising adjusted R2 values. In terms of emotions, fear seemed more relevant for the predictions of the DOSPERT scores, whereas happiness seemed more associated with the Big Five personality traits. Being neutral in front of a video can also play a role in determining the individual's personality characteristics. Remember that the facial emotion recognition system returns this value if it cannot assign any other emotion with a sufficiently high threshold, corresponding to the individual sitting in front of the computer with an unmoving face. We also see that different videos triggered a variety of emotional responses, which were possibly useful for the prediction of different traits. All the relationships explored in this study could be further investigated in future research in order to better analyze their meaning from a psychological perspective.

FIG. 2A summarizes findings from the regression models, providing evidence to the importance of each video and emotion for the prediction of individual traits. For example, we can observe that videos number 14, 9, and 2 were those that triggered the most useful emotional responses. Among emotions, fear and happiness were those most used to make predictions, with fear being particularly relevant for the DOSPERT traits.

### Predicting Personality and Morals Using Machine Learning

While correlations and regressions showed promising results, we wanted to complete our analysis to explore non-linear relationships and the possibility of making predictions by using machining learning and considering a test sample (a subset of observations) not used for model training. In particular, we binned the continuous scores of our dependent variables into three classes in order to understand if values were high, medium, or low. Subsequently, we used a gradient boosting approach to make predictions, namely, Xgboost [35]. We trained our models using 10-Fold Cross Validation and the SMOTE technique [36] in order to treat unbalanced classes. ADASYN was also used as an alternative to SMOTE [37], in the cases where this led to improved forecasts. In Table 7, the inventions present the results of these forecasting exercises, made on 10% of observations that were held out for testing prediction accuracy

FIG. 2A illustrates alluvial diagrams illustrating the significant relationships between videos, emotions, and personality. FIG. 2B illustrates alluvial diagrams between emotions and individual traits.

As the table shows, the inventions obtained good prediction results, both in terms of average accuracy and Cohen's Kappa. Only for the health perceived trait of the DOSPERT scale did we obtain an accuracy score that was below 70% (60% average accuracy and a Kappa value of 0.38). This confirms our original hypothesis that facial emotion recognition can be used to predict personality and other individual traits. Similarly, to the regression models, different features were more important for the prediction of personality and other individual traits. In order to evaluate the contribution of each feature to model prediction, we used Shapley additive explanations (SHAP) [38,39]. In the following (FIG. 3 to FIG. 6), we provide some examples, while the remaining charts are shown in Table A1 of Gloor. In the following figures, FIG. 3 to FIG. 24, we provide some examples.

As the Shapley charts illustrate, again the emotions happiness and fear were found to have the strongest predictive power. However, we cannot make any claim about what emotional response to which movie predicts what personality characteristics. This is not the point of this paper. The point is that “your emotional response predicts your personality characteristics and moral values”. Identification of the most emotionally provocative movies is most likely dependent on the individual personality and values of the viewer, which is also related to local cultures and values. It would therefore be another research project to precisely identify a minimal set of short movies that consistently provoke the most expensive emotions that are the most indicative of an individual's personality and morals.

### Limitations, Future Work, and Conclusions

In this work, we show that Table A1 of Gloor can be used for the task of facial emotion recognition, producing features that can in turn predict people's personality and moral values. Ours is an exploratory analysis with regard to associations found between different individual traits and emotions produced in response to a different set of audio-visual stimuli. These relationships could be further investigated in future research in order to better understand their meaning from a psychological perspective.

Future research should consider more control variables, which we could not collect in our experiment (due to privacy arrangements), such as age, gender, and ethnicity of experiment participants. Similarly, a different set of videos could be taken into account, also looking for the optimal set of stimuli that could produce an emotional response better associable to specific individual differences.

Our research has both practical and theoretical implications. On the theoretical side, it further confirms the insight that moral affect—emotions in response to positive and negative experiences—are at the centre of our ethical values. On the practical side, our approach offers a novel and more honest way to measure personality characteristics, attitudes to risk, and moral values.

As has been discussed above, while humans tend to misjudge personality and moral values of others and themselves, Table A1 of Gloor provides an honest virtual mirror assisting in this task.

The present inventions have shown that while humans frequently are incapable of looking behind the facade of the face and “read the mind in the eyes”, artificial intelligence can lend a helping hand to people who have difficulties in this task.

The one or more personality characteristics determined by the user personality estimator are stored in the user profile associated with the user. In one embodiment, the user personality estimator identifies a probability distribution of personality characteristics the user is likely to have from the linguistic features and the retrieved characteristics, and the probability distribution of personality characteristics is stored in the user profile of the user. Storing the distribution of personality characteristics allows the social networking system to account for uncertainty in determination of the user's personality characteristics by storing levels of personality characteristics that the user is likely to have as well as storing alternative levels of personality characteristics that the user may have.

The social networking system uses the personality characteristics associated with the user to select additional content for the user. For example, a user's personality characteristics may be used along with other user information, such as affinities, to select stories for inclusion in the user's newsfeed, to select advertisements for presentation to the user, or to select recommendations of actions for the user to perform social networking system. As another example, stored personality characteristics may be used as targeting criteria for advertisers, allowing advertisement selection to account for particular personality characteristics to increase the likelihood that the user accesses or otherwise positively interacts with a selected advertisement. For example, the product presented in an advertisement may be modified based on one or more of the personality characteristics stored in the user profile.

Additionally, personality characteristics associated with the user may be used to select content for other users of the social networking system. For example, the user's personality characteristics may be used to determine whether content associated with the user is distributed to other users connected to the user.

In one embodiment, the user's personality characteristics may be used to determine whether stories describing actions by the user are included in a news feed of another user or used to determine the location of a story describing an action by the user in the other user's news feed. As another example, the user's personality characteristics may be used when selecting suggested actions for other users that involve the user; as a specific example, the user's personality characteristics may be used to determine whether to recommend that an additional user establish a connection with the user in the social networking system

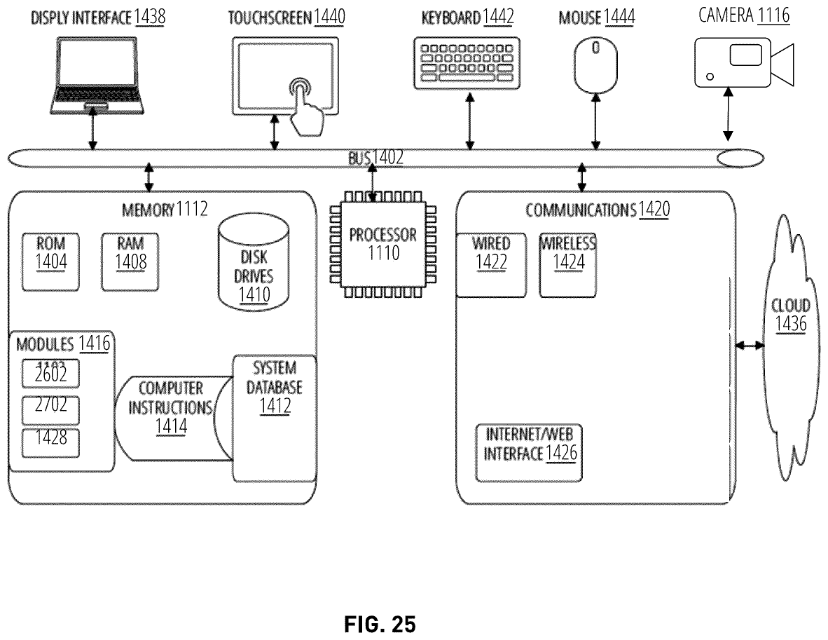

FIG. 25 is a possible hardware configuration. In this configuration of the computerized electronic device, a bus 1402 provides the exchange of data between various components. A processor 1110 may coordinate activity on the bus, retrieving computer instructions 1414 and data from the other devices. The processor could be a microprocessor, a system-on-a-chip, an ASIC, an optical processor, or a similar device. The processor 1110 could receive instructions and data from a touchscreen 1440, a keyboard 1442, a mouse 1444, a display interface 1438, a smartwatch, a camera 1116, a smartphone, a tablet, a telephone, an Internet/Web Interface 1426, or from a wired 1422 or wireless 1424 network (possibly from the cloud 1436).

The hardware configuration may include a communications 1420 subsystem that provides a wired 1422 and wireless 1424 access to external devices through direct connection, local area networks, wide area networks, and the Internet or the cloud 1436. Within the communications 1420 subsystem could be interfaces to the Internet/Web Interface 1426 (such as support for web browsers and web servers). In some embodiments, some or all of this functionality may be moved to the processor 1110 and memory 1112 or remotely to a server accessible through the wired 1422 or wireless 1424 network interfaces.

The memory 1112 could be made up of ROM 1404, RAM 1408, disk drives 1410, optical storage, and similar storage devices. The memory 1112 could be local to the processor over the bus 1402 or remote or any combination thereof. The memory 1112 could include a system database 1412 of the communication data 1114 retrieved by the data retrieval module 1102. The memory 1112 could also include modules 1416 such as the Build Machine Learning Model 2602, Predict personality based on face 2702 module, and other modules 1428. These modules could comprise non-transitory machine readable instructions for the processor 1110. The memory 1112 may also store the machine learning model and the emotionally provoking movie snippets 102.

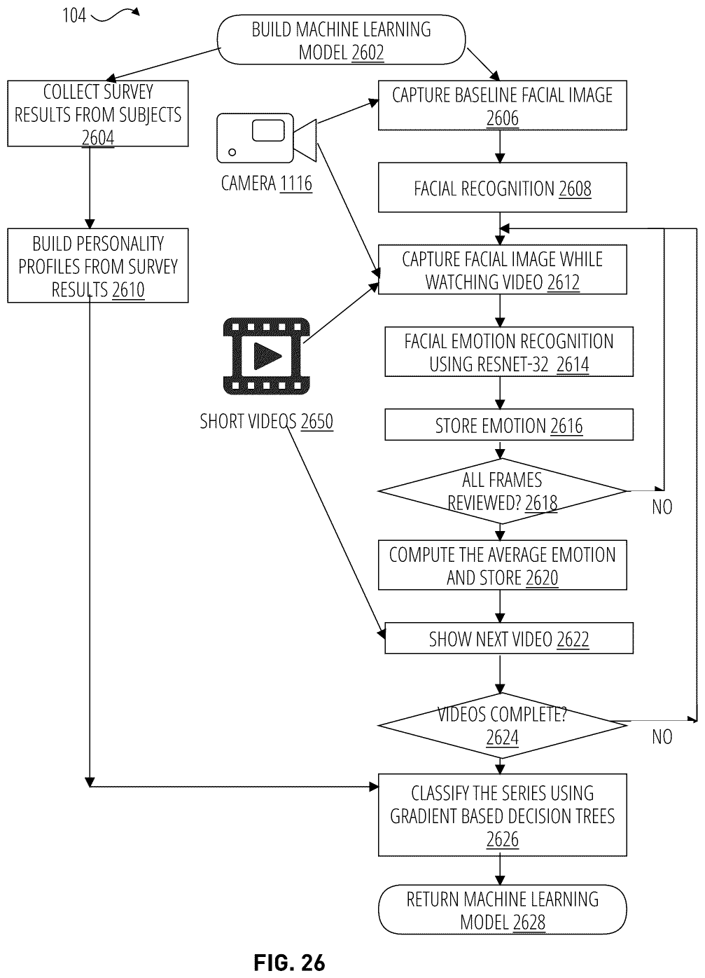

FIG. 26 is a block diagram of one possible embodiment of the creation of the machine learning model 104. The Build Machine Learning Model 2602 step takes known methodologies for determining personality traits using surveys and correlates the results from those surveys with the results of the video/facial emotion recognition methodology, tuning the machine learning model so that personality traits can be determined using a series of short videos. In the building of the machine learning model, hundreds of subjects 106 are used to create the machine learning model 104 with a statistically significant number of subjects 106.

The first step is to collect personality surveys 101 results from the subjects in block 2604. One or more of the revised Neuroticism, Extraversion, Openness Five Factors (NEO FFI) personality inventory, the Haidt moral foundations test, the Schwartz personal value system, and the domain-specific risk-taking scale (DOSPERT) surveys are used to make a determination of the personality traits of each of the subjects 106.

Each subject 106 is seated before the camera 1116, and recorded. First, a baseline facial image of the subject is captured 2606. Then the system performs facial recognition 2608 to make sure that the subject is in view of the camera 1116 and that the facial images can be read.

The first of the short videos 2650 (emotionally provoking movie snippets 102) then starts. The facial image is captured 2612 as the user watches the emotionally provoking movie snippets 102, 2650, perhaps once per second. Next, the image is processed through a Resnet-32 or EfficientNet machine learning engine to provide an emotion characterization for this frame of this emotionally provoking movie snippets 102, 2650 for this subject. The emotion determination is stored in block 2616. Once all of the frames of this emotionally provoking movie snippets 102, 2650 are viewed and the subjects reactions are stored, the average of the emotions for this emotionally provoking movie snippets 102, 2650 is calculated and stored in a vector 2620, and the next video is shown 2622. If there are additional videos 2624, then the steps of this paragraph are repeated until all of the short videos 2650 are viewed.

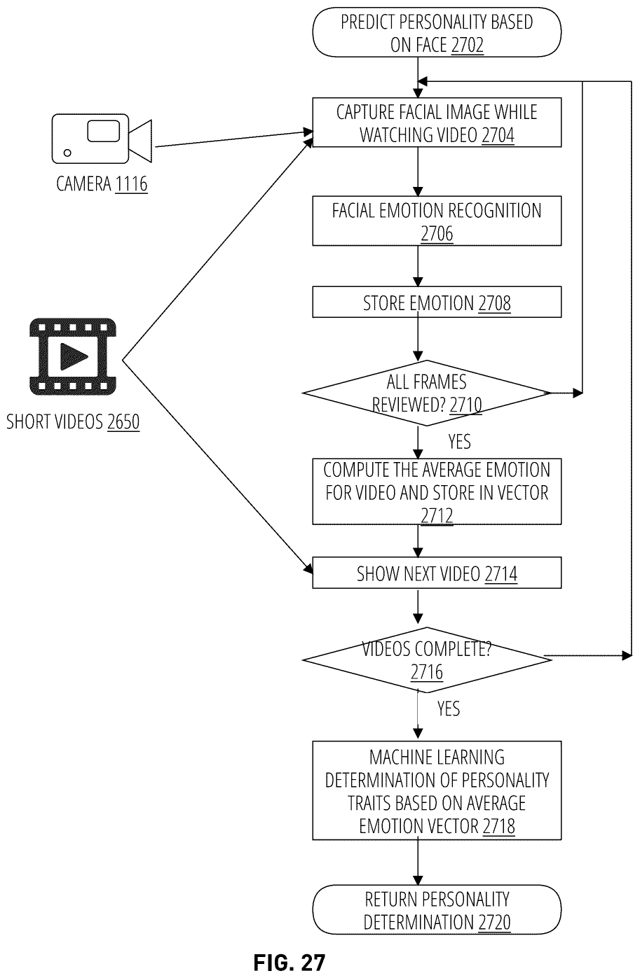

Then, the vector of the average emotion for each video is compared to the survey answers in block 2610 to build a machine learning model that can take any vector of the average emotion for each video and express the personality traits of the subject. When this flow chart is complete 2628, the machine learning model is stored for using in FIG. 27.

FIG. 27 is a flow chart of the use of the machine learning model to predict personality based on face 2702. The user sits in front of the camera 1116 where he can watch emotionally provoking movie snippets 102, 2650. In some embodiments, the user sits at a laptop watching the emotionally provoking movie snippets 102, 2650 on the display interface 1438 while the camera 1116 records the user's interaction.

While the emotionally provoking movie snippets 102, 2650 are viewed by the user, the user's facial image is captured 2704, perhaps once per second. Facial emotion recognition software 2706 is run to determine the emotion in the user's face. The emotion is stored 2708. Once all frames of the emotionally provoking movie snippets 102, 2650 are viewed 2710, the average emotion for this emotionally provoking movie snippets 102, 2650 is calculated 2712 and stored in a vector. Then the next emotionally provoking movie snippets 102, 2650 is shown 2714. When all of the emotionally provoking movie snippets 102, 2650 have been viewed 2716, the vector is submitted to the machine learning model (this is the model 2628 from FIG. 26) to determine the personality traits based on the vector 2718. These personality traits are returned to the calling software 2720, perhaps to be displayed on the display interface 1438 or reported to a doctor or human resource person through the communications 1420 interface.

### BEST MODE OF CARRYING OUT THE INVENTIONS

At its best, the present inventions describe a system for predicting personality and morals through facial emotion recognition, comprising a machine learning system that predicts personality characteristics of individuals on the basis of their face; a means of tracking the emotional response of the individual's face through facial emotion recognition while watching a series of at least fifteen short videos of different genres (2704), and a calibration module, wherein emotional responses of people are analyzed through their facial expression as they watch the videos (Block 2718), their emotional responses are analyzed through their facial expression.

The personality characteristics and moral values are within the revised Neuroticism, Extraversion, Openness Five Factors (NEO FFI) personality inventory, the Haidt moral foundations test, the Schwartz personal value system, and the domain-specific risk-taking scale (DOSPERT). The tools for emotional response to the videos personality characteristics and moral values of an individual are predicted through their emotional response to the emotionally provoking movie snippets 102, 2650 as shown in their face, with an accuracy of up to 86% using gradient-boosted trees. The mix of different videos are enabled to predict different personality characteristics by different videos to allow for accurate prediction.

Also described is a method of predicting personality and morals through facial emotion recognition, comprising steps of creating a machine learning model by:
a. predicting personality characteristics of individuals on the basis of their face using a machine learning system in block 2626;
b. tracking the emotional response of the individual's face through facial emotion recognition (FER) while watching a series of at least fifteen short videos of different genres in block 2612;
c. calibrating and analyzing users' emotional responses through their facial expression in block 2620, and
d. validating individuals' surveys of personality characteristics and moral values to the revised NEO FFI personality inventory, the Haidt moral foundations test, the Schwartz personal value system, and the domain-specific risk-taking scale (DOSPERT), in block 2604 and block 2610.

At the step of predicting personality characteristics and moral values, tools for emotional response to the videos personality characteristics and moral values of an individual are applied through their emotional response to the videos as shown in their face, with an accuracy of up to 86% using gradient-boosted trees. At the step of emotional response, a mix of different videos are enabled to predict different personality characteristics for accurate predictions for all personality characteristics.

In another embodiment, the inventions describe a computer-implemented system for predicting personality and morals through facial emotion recognition, comprising at least one processor implemented to execute computer-readable instructions including, the at least one process, a pre-processing unit for classifying a target facial emotion recognition that is a target of personality recognition and a target who showed the face from the inputted facial emotion recognition; an emotion information prediction unit for predicting a personality of a target based on the facial emotion recognition, a facial emotion recognition personality predicting unit for predicting a personality category of the target based on the target facial emotion recognition; and an emotion-personality dependency analysis unit for recognizing the target's personality by analyzing the dependence between the predicted emotion and the predicted personality category.

### INDUSTRIAL APPLICATION

The present inventions apply to human personality and morals. In particular, it avails a process of predicting personality and morals through facial emotion recognition. The inventions provide a novel system for predicting personality and morals through facial emotion recognition, comprising a machine learning system is able to predict personality characteristics of individuals on the basis of their face. In addition, a method of tracking the emotional response of the individual's face through facial emotion recognition (FER) while watching a series of 15 short videos of different genres; and calibration emotional responses are analyzed through their facial expression in a simple and friendly manner.

These inventions can be used in:
Clinical Psychology & Mental Health: Automated personality assessment for therapists and counselors.
Recruitment & HR Analytics: AI-driven personality screening for job candidates.
Marketing & Behavioral Economics: Understanding consumer preferences based on risk-taking and moral values.
Social Media & Content Personalization: Personalized content recommendation based on emotional and moral profiles.
Security & Law Enforcement: Behavioral profiling for risk assessment in security screenings.

The present inventions advance the field of psychological assessment using AI, offering a deep learning-driven FER system for predicting personality traits, risk-taking behaviors, and moral values. Unlike prior methodologies that rely on static datasets, this system dynamically captures emotional responses to video stimuli, providing more accurate and scalable personality analysis.

This document, therefore, describes a novel AI-driven system for real-time, automated personality and moral trait prediction with broad industrial applicability and strong scientific backing from existing psychological frameworks.

The language used in the specification has been principally selected for readability and instructional purposes, and it may not have been selected to delineate or circumscribe the inventive subject matter. It is therefore intended that the scope of the inventions be limited not by this detailed description, but rather by any claims that issue on an application based hereon. Accordingly, the disclosure of the embodiments of the inventions are intended to be illustrative, but not limiting, of the scope of the inventions, which is set forth in the following claims.

The foregoing description of the embodiments of the inventions have been presented for the purpose of illustration; it is not intended to be exhaustive or to limit the inventions to the precise forms disclosed. Persons skilled in the relevant art can appreciate that many modifications and variations are possible in light of the above disclosure.

Some portions of this description describe the embodiments of the inventions in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the inventions may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the inventions may also relate to a product that is produced by a computing process described herein. Such a product may comprise information resulting from a computing process, where the information is stored on a non-transitory, tangible computer readable storage medium and may include any embodiment of a computer program product or other data combination described herein.

1. Non-transitory machine readable instructions for execution on a processor, the non-transitory machine readable instructions directing the processor to:
display a video from a memory on a display interface connected to the processor;
capture a frame of a facial image of a user with a camera connected to the processor, and storing the frame in the memory;
determine an emotion in the frame with a facial emotion recognition software;
store the emotion in the memory;
when the video is completed, average the emotions stored in the memory and store the average in a vector stored in the memory;
repeat for a plurality of videos;
execute a machine learning model to convert the vector into a list of personality traits; and
display the personality traits on the display interface.

2. The non-transitory machine readable instructions for execution on the processor as in claim 1, where the plurality of videos are emotionally provoking movie snippets (102).

3. The non-transitory machine readable instructions for execution on the processor as in claim 1, where the facial emotion recognition software is ResNet-32.

4. The non-transitory machine readable instructions for execution on the processor as in claim 1, where the machine learning model is trained using personality surveys (101).

5. The non-transitory machine readable instructions for execution on the processor as in claim 4, where the personality surveys (101) include a Neuroticism, Extraversion, Openness Five Factors (NEO FFI) personality inventory.

6. The non-transitory machine readable instructions for execution on the processor as in claim 4, where the personality surveys (101) include a Haidt moral foundations test.

7. A method comprising:
displaying a video stored in a memory on a display interface, the display interface and the memory connected to a processor;
capturing a frame of a facial image of a user with a camera connected to the processor and storing the frame in the memory;
determining an emotion in the frame with a facial emotion recognition software;
storing the emotion in the memory;
when the video is completed, average the emotions stored in the memory and store the average in a vector in the memory;
repeat for a plurality of videos;
execute a machine learning model to convert the vector into a list of personality traits; and
display the personality traits on the display interface.

8. The method of claim 7 where the plurality of videos are emotionally provoking movie snippets (102).

9. The method of claim 7 where the facial emotion recognition software is ResNet-32.

10. The method of claim 7 where the facial emotion recognition software is EfficientNet.

11. The method of claim 7 where the machine learning model is trained using personality surveys (101).

12. The method of claim 11 where the personality surveys (101) include a Schwartz personal value system.

13. The method of claim 11 where the personality surveys (101) include domain-specific risk-taking scale.

14. An apparatus comprising:
a processor;
a memory connected to the processor, the memory comprising a video;
a display interface connected to the processor;
a camera connected to the processor;
where the display interface displays the video from the memory;
where the camera captures a plurality of frames of facial images of a user and stores the plurality of frames in the memory;
where the processor executes a facial emotion recognition software to determine an average emotion in the plurality of frames and stores the average emotion for the video in a vector stored in the memory;
where the processor repeats the display of the video, the capture of the plurality of frames, execution of the facial emotion recognition software, and the storage of the average emotion in the vector for a plurality of videos;
where the processor executes a machine learning model to convert the vector into a list of personality traits; and
where the display interface displays the personality traits.

15. The apparatus of claim 14 the plurality of videos are emotionally provoking movie snippets (102).

16. The apparatus of claim 14 where the facial emotion recognition software is a convolutional neural network.

17. The apparatus of claim 16 where the convolutional neural network uses a ResNet-34 architecture.

18. The apparatus of claim 14 where the machine learning model is trained using personality surveys (101).

19. The apparatus of claim 18 where the personality surveys (101) include the Neuroticism, Extraversion, Openness Five Factors (NEO FFI) personality inventory.

20. The apparatus of claim 18 where the personality surveys (101) include a Schwartz personal value system.
